(19) United States
(12) Patent Application Publication
(10) Pub. No.: US 2012/0218795 A1
(43) Pub. Date: Aug. 30, 2012

(54) PULSE WIDTH MODULATED CONTROL FOR HYBRID INVERTERS

(75) Inventor: Liviu Mihalache, Bensalem, PA (US)

(73) Assignee: Siemens Corporation, Iselin, NJ (US)

(21) Appl. No.: 13/233,254

(22) Filed: Sep. 15, 2011

Related U.S. Application Data
(60) Provisional application No. 61/447,168, filed on Feb. 28, 2011.

(51) Int. Cl. H02M 7/537

(52) U.S. Cl. 363/97; 363/131

(57) ABSTRACT

A single-phase hybrid multilevel inverter is described that combines a 3-level leg and a 2-level leg to reduce the number of overall switching devices for a 5-level inverter. The 2-level inverter leg switches at a fundamental frequency and the 3-level flying capacitor leg uses PWM modulation to switch resulting in a low THD output voltage spectrum. The control method developed for the single-phase inverter is used to build a three-phase inverter comprised of three single-phase hybrid inverters in order to achieve a line-to-neutral voltage having five levels and a line-to-line voltage having nine levels.

### CROSS REFERENCE TO RELATED APPLICATIONS

This application claims the benefit of U.S. Provisional Application No. 61/447,168, filed on Feb. 28, 2011, the disclosure which is incorporated herein by reference in its entirety.

### BACKGROUND OF THE INVENTION

The invention relates generally to DC to AC inverters. More specifically, the invention relates to a 5-level single-phase inverter that comprises a 3-level leg and a 2-level leg having a reduced number of switching devices, which leads to lower losses and increased efficiency. The control method developed for the single-phase inverter is then used to build a three-phase inverter comprised of three single-phase hybrid inverters in order to achieve a line-to-neutral voltage having five levels and a line-to-line voltage having nine levels.

Today, the power industry has revived and entered a new age using renewable energy, and high efficiency power generation, transmission and distribution where multilevel power converters can assume significant roles.

Multilevel inverters offer a distinct advantage over their 2-level counterparts due to their ability to synthesize AC waveforms with lower Total Harmonic Distortion (THD), and smaller

$$\frac{d v}{d t}$$

and common-mode voltage. Traditionally, multilevel power conversions are dominantly used in the applications of medium voltage AC drives, flexible AC transmission systems (FACTS), and High-Voltage DC (HVDC) transmission systems, because single power semiconductor devices cannot handle high voltage. However, the higher cost of multilevel inverters has restricted its presence in low voltage applications.

A multilevel structure can be considered as an AC voltage synthesizer realized from multiple discrete DC voltage sources. Multiple, equal DC sources are required. Multilevel inverters provide an AC output waveform at discrete voltage levels. The more steps or levels generate a smoother sinusoidal waveform and reduce the amount of output filtering. Practically, it is a trade-off to select the number of levels considering the converter complexity and filter requirements. By optimizing the angles and heights of steps, certain lower order harmonics can be cancelled. In addition, the harmonic spectrum can be reduced by using Pulse-Width Modulation (PWM) techniques at each level.

Recently, there is a trend towards implementing multilevel solutions in low voltage renewable energy applications, e.g., in a solar farm where grid connected inverters are required to feed high quality current into the electric distribution system. Also, interests revive multilevel topologies for their ability to reduce the mass and size of LC filters and to eliminate line-frequency transformers.

Numerous multilevel topologies have been proposed and studied for utility and motor drive applications. FIG. 1A shows a prior art single-phase, 5-level diode-clamped or Neutral-Point-Clamped (NPC) inverter leg, FIG. 1B shows a prior art capacitor-clamped or flying capacitor inverter leg and FIG. 1C shows a prior art cascaded H-bridge inverter with separate DC inputs. A three-phase 5-level inverter would require 24 switching devices. The control complexity increases with levels.

There is a need for a simplified 5-level, low THD inverter.

### SUMMARY OF THE INVENTION

The inventor has discovered that it would be desirable to have a single-phase hybrid multilevel inverter that combines a 3-level leg and a 2-level leg to reduce the number of overall switching devices for a 5-level inverter. A three-phase inverter embodiment comprised of three single-phase hybrid inverters results in a line-to-neutral voltage having five levels and a line-to-line voltage having nine levels. Embodiments use a smaller number of switching devices and are viable in applications where galvanic isolation is required, e.g., in solar power systems and UPS applications.

Embodiments provide a single-phase 5-level inverter topology that combines a 3-level flying capacitor leg with a 2-level inverter leg. The 2-level inverter leg switches at a fundamental frequency and the 3-level leg switches at a higher frequency. Embodiments achieve an optimum single-phase voltage inverter with automatic capacitor balancing using a minimum number of switching devices.

Embodiments employ a PWM method that provides a low THD output voltage spectrum when compared to phase-shifted PWM that is typically used for flying capacitor topologies. These single-phase embodiments are combined to form a three-phase 5-level inverter.

One aspect of the invention provides a hybrid inverter. Inverters according to this aspect of the invention comprise a topology comprising a 3-level flying capacitor leg coupled in parallel with a half-bridge 2-level leg, the 3-level flying capacitor leg comprising four unidirectional controlled switches coupled together in series that define a positive node (+) beginning at a first switch S1, a node C between the first switch S1 and a second switch S2, a node A between the second switch S2 and a third switch S3, a node D between the third switch S3 and a fourth switch S4 and a negative node (−) after the fourth switch S4, and a capacitor C1 coupled to nodes C and D, and the half-bridge 2-level leg comprising two unidirectional controlled switches coupled together in series that define a positive node (+) beginning at a fifth switch S5, a node B between the fifth switch S5 and a sixth switch S6 and a negative node (−) after the sixth switch S6, and an alternating current output defined between nodes A and B.

Another aspect of the inverter is an inverter switch waveform synthesizer configured to generate switch signals S1PULSE, S2PULSE, S3PULSE, S4PULSE, S5PULSE and S6PULSE that control the first switch S1, the second switch S2, the third switch S3, the fourth switch S4, the fifth switch S5, and the sixth switch S6 respectively comprising a reference sine wave generator configured to output a reference sine wave f(t) at a fundamental frequency f_{f}, amplitude m, phase angle φ and time t, a first comparator configured to receive the reference sine wave f(t) and compare the reference sine wave f(t) with zero to generate the switch signal waveform S5PULSE wherein if the reference sine wave is greater than 0 switch S5 is off and if the reference sine wave is less than or equal to 0 switch S5 is on, a not function configured to receive the switch signal waveform S5PULSE and output the switch signal waveform S6PULSE, a first frequency divider configured to receive the switch signal waveform S5PULSE and divide the switch signal waveform S5PULSE by 2 to generate an SQF signal, a mapping function configured to map the reference sine wave f(t) wherein the discrete time value of the reference sine wave is M and if M>0, M is mapped according to f(M)=2M−1 and if M≦0, M is mapped according to f(M)=2M+1, a second comparator configured to receive the mapped f(M) values and compare the mapped f(M) values with a positive triangle carrier waveform TC1 wherein the second comparator outputs a signal VAOP that is 1 when f(M)>TC1(t) and 0 when f(M) is not greater than TC1(t), a third comparator configured to receive the mapped f(M) values and compare the mapped f(M) values with a negative triangle carrier waveform TC2 wherein the third comparator outputs a signal VAON that is 1 when f(M)>TC2(t) and 0 when f(M) is not greater than TC2(t), a positive square pulse generator with a frequency fₛ configured to output a signal SQP based on the positive triangle carrier TC1 period Tₛ wherein if

$$0 < t < \frac{{T}_{s}}{2} ,$$

the signal SQP is 1 and if

$$\frac{{T}_{s}}{2} < t < {T}_{s} ,$$

SQP is 0, a negative square pulse generator with a frequency fₛ configured to output a signal SQN based on the negative triangle carrier TC2 period Tₛ wherein if

$$0 < t < \frac{{T}_{s}}{2} ,$$

the signal SQN is 0 and if

$$\frac{{T}_{s}}{2} < t < {T}_{s} ,$$

the signal SQN is 1, a second frequency divider configured to receive the signal SQP, divide the signal SQP by 2 and output a signal SQPO2 that has a frequency

$$\frac{{f}_{s}}{2}$$

wherein if 0<t<Tₛ, the signal SQPO2 is 1 and if Tₛ<t<2·Tₛ, the signal SQPO2 is 0, a third frequency divider configured to receive the signal SQN, divide the signal SQN by 2 and output a signal SQNO2 that has a frequency

$$\frac{{f}_{s}}{2}$$

wherein if 0<t<Tₛ, the signal SQNO2 is 0 and if Tₛ<t<2·Tₛ, the signal SQNO2 is 1, a fourth frequency divider configured to receive the signal SQPO2, divide the signal SQPO2 by 2 and output a signal SQPO4 that has a frequency

$$\frac{{f}_{s}}{4}$$

wherein if 0<t<2 T, the signal SQPO4 is 1 and if 2·Tₛ<t<4·Tₛ, the signal SQPO4 is 0, a fifth frequency divider configured to receive the signal SQNO2, divide the signal SQNO2 by 2 and output a signal SQNO4 that has a frequency

$$\frac{{f}_{s}}{4}$$

wherein if 0<t<2·Tₛ, the signal SQNO4 is 0 and if 2·Tₛ<t<4·Tₛ, the signal SQNO4 is 1, a signal S1P generated from signals SQP, SQN, SQPO2, SQNO2, SQPO4, SQNO4 and VAOP defined as
SQPO4(SQPO2+SQP+VAOP)+SQNO4[VAOPSQPO2+SQNO2(SQN+VAOP)], a signal S2P generated from signals SQP, SQN, SQPO2, SQNO2, SQPO4, SQNO4 and VAOP defined as
SQNO4(SQPO2+SQP+VAOP)+SQPO4[VAOPSQPO2+SQNO2(SQN+VAOP)], a signal S1N generated from signals VAON and SQPO2 defined as VAONSQPO2, a signal S2N generated from signals VAON and SQNO2 defined as VAONSQNO2, a fourth comparator configured to receive the mapped f(M) values and compared the mapped f(M) values wherein if f(M)>0, output a 1 and if f(M)≦0, output a 0, a first signal selector configured to receive the signals S1P and S1N, and the output from the fourth comparator, and output a signal SX wherein if the fourth comparator output is 1, the signal S1P is output and if the fourth comparator output is 0, the signal S1N is output, a second signal selector configured to receive the signals S2P and S2N, and the output from the fourth comparator, and output a signal SY wherein if the fourth comparator output is 1, the signal S2P is output and if the fourth comparator output is 0, the signal S2N is output, and the switch signal S1PULSE is generated from the signals SX, SY and SQF defined as SX S̅Q̅F̅+SYSQF, the switch signal S2PULSE is generated from the signals SX, SY and SQF defined as SY S̅Q̅F̅+SXSQF, the switch signal S3PULSE is generated defined as S̅2̅P̅U̅L̅S̅E̅, and the switch signal S4PULSE is generated defined as S̅1̅P̅U̅L̅S̅E̅.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A is a prior art half-bridge diode-clamped 5-level inverter topology.

FIG. 1B is a prior art half-bridge flying capacitor 5-level inverter topology.

FIG. 1C is a prior art cascaded H-bridge flying capacitor 5-level inverter topology.

FIG. 2 is an exemplary single-phase 5-level hybrid inverter.

FIG. 3 is an exemplary three-phase 5-level hybrid inverter with transformer isolation.

FIGS. 4A, 4B, 4C, 4D, 4E and 4F are an exemplary single-phase 5-level hybrid inverter switch signal waveform synthesizer.

FIG. 5 shows exemplary plots of reference sine wave f(t), switch signal waveforms S5PULSE and S6PULSE for the half-bridge 2-level leg switches S5 and S6, respectively, and signal SQF which is synchronous to the reference sine wave M. The frequency of signal SQF is half of the reference sine wave M.

FIG. 6 shows an exemplary plot of reference sine wave f(t), a mapping function table for a given sinusoidal reference M and voltage output levels between nodes A and B synthesized by the inverter for different amplitudes of the sinusoidal reference, and an exemplary plot f(M) of the mapped reference sine wave f(t).

FIG. 7 shows exemplary plots of reference sine wave f(t), positive triangle carrier TC1, mapping function f(M) and signal VAOP.

FIG. 8 shows exemplary plots of reference sine wave f(t), negative triangle carrier TC2, mapping function f(M) and signal VAON.

FIG. 9 shows exemplary plots of reference sine wave f(t), positive triangle carrier TC1, and signals SQP, SQPO2 and SQPO4.

FIG. 10 shows exemplary plots of reference sine wave f(t), negative triangle carrier TC2, and signals SQN, SQNO2 and SQNO4.

FIG. 11 shows exemplary plots of reference sine wave f(t), switch signal waveforms S1PULSE, S2PULSE, S3PULSE, S4PULSE, S5PULSE and S6PULSE for switches S1 S2, S3, S4, S5 and S6, respectively, and voltage output levels between nodes A and B.

FIG. 12 is a table showing simulation parameters.

FIG. 13 shows exemplary plots of voltages between the fundamental switching node B and a fictitious VDC midpoint (top), and the PWM switching node A and a fictitious VDC midpoint (bottom).

FIG. 14 shows exemplary plots of output waveforms of line-line voltage (top) and line-neutral voltage (bottom) for a reference sine wave f(t) having an amplitude m=0.92.

FIG. 15 is an exemplary plot that shows phase A, B and C current waveforms for a reference sine wave f(t) having an amplitude m=0.92.

FIG. 16 is an exemplary plot that shows harmonic spectra of output phase current.

FIG. 17 is an exemplary plot that shows flying capacitor voltage for a reference sine wave f(t) having an amplitude m=0.92.

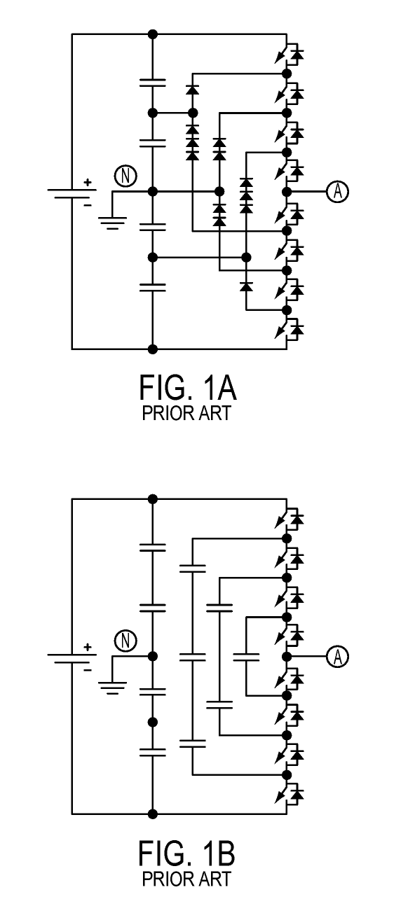

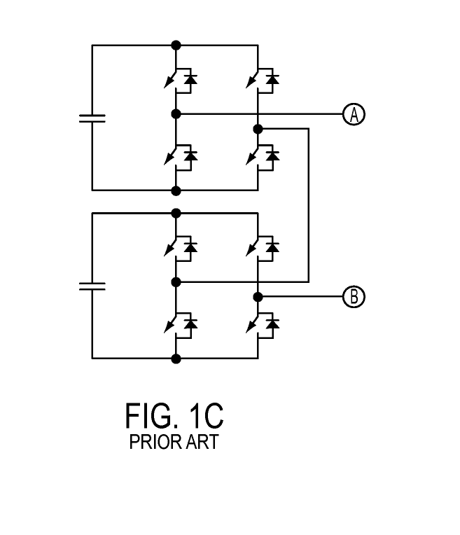

### DETAILED DESCRIPTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having,” and variations thereof herein is meant to encompass the items listed thereafter and equivalents thereof as well as additional items.

The terms “connected” and “coupled” are used broadly and encompass both direct and indirect connecting, and coupling. Further, “connected” and “coupled” are not restricted to physical or mechanical connections or couplings.

It should be noted that the invention is not limited to any particular software language described or that is implied in the figures. One of ordinary skill in the art will understand that a variety of software languages may be used for implementation of the invention. It should also be understood that some of the components and items are illustrated and described as if they were hardware elements, as is common practice within the art. However, one of ordinary skill in the art, and based on a reading of this detailed description, would understand that, in at least one embodiment, components may be implemented as software or hardware.

Embodiments of the invention provide 5-level, hybrid inverter topologies, switching methods, and computer-usable media storing computer-readable instructions for the switching methods. The switching methods may be deployed as software as an application program tangibly embodied on a program storage device. The application code for execution can reside on a plurality of different types of computer readable media known to those skilled in the art.

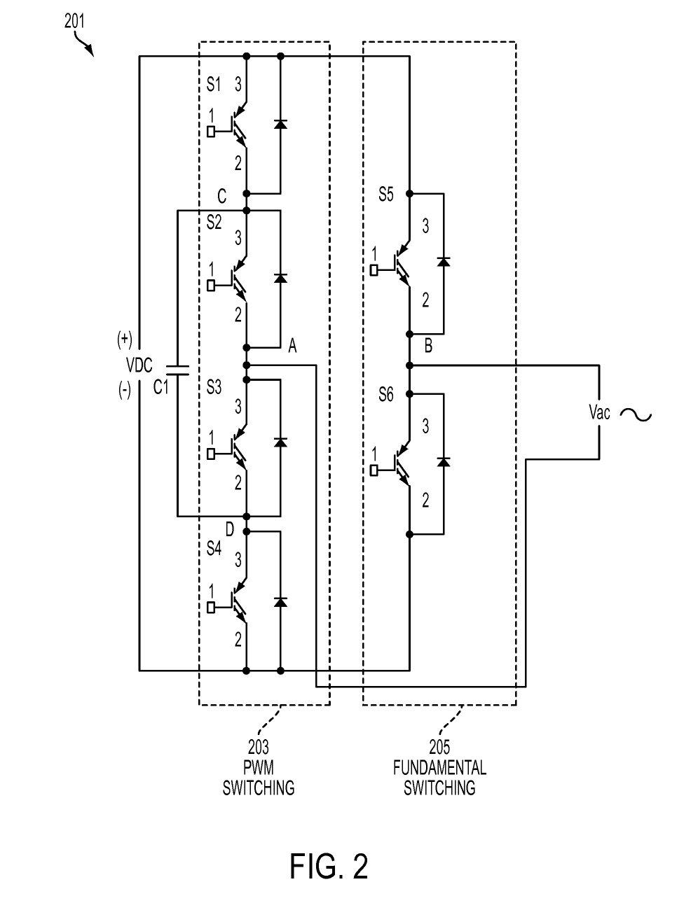

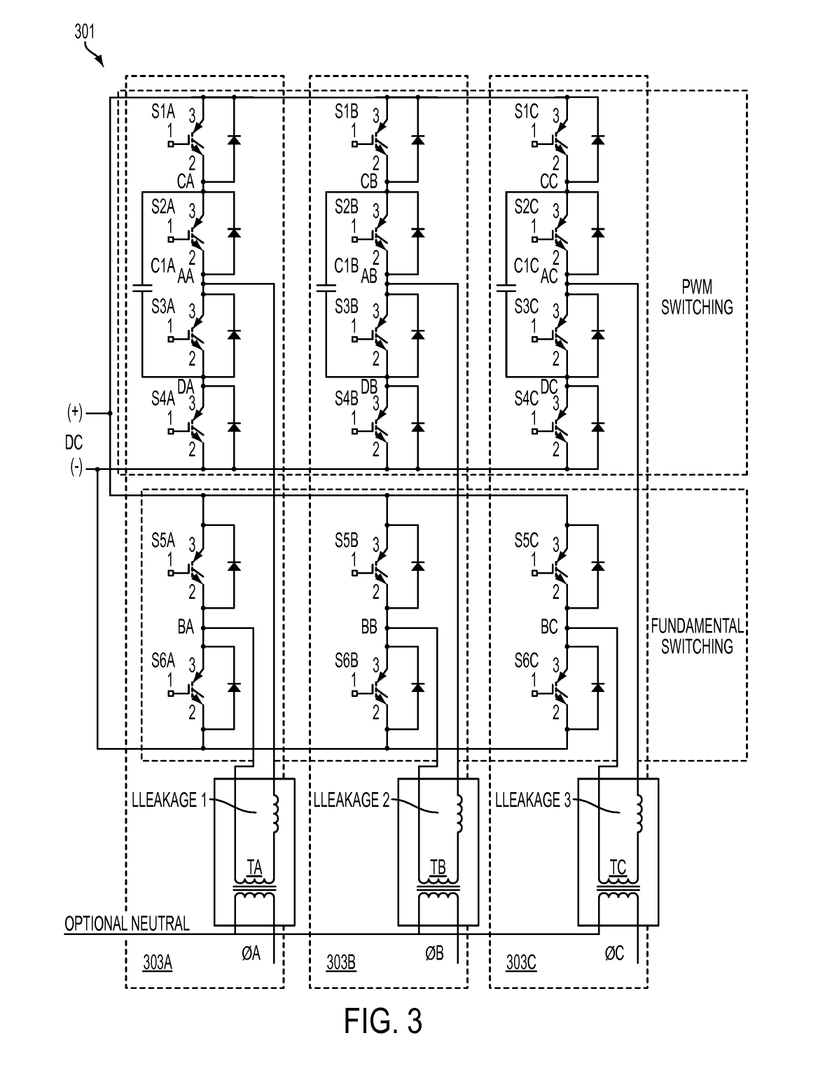

FIG. 2 shows a single-phase, 5-level inverter topology 201 and FIG. 3 shows a three-phase, 5-level inverter topology 301 that comprises three single-phase 201, 5-level inverters 303A, 303B, 303C with line matching transformers TA, TB and TC.

The single-phase, 5-level inverter topology 201 comprises a VDC source input across positive (+) and negative (−) nodes, a 3-level flying capacitor PWM switching leg 203, a half-bridge 2-level fundamental switching leg 205 and output nodes A and B.

The 3-level flying capacitor leg 203 comprises four unidirectional controlled switches S1, S2, S3, S4 coupled together in series and a flying capacitor C1. A positive node (+) is defined beginning at the first switch S1, a node C is defined between the first switch S1 and the second switch S2, a node A is defined between the second switch S2 and the third switch S3, a node D is defined between the third switch S3 and the fourth switch S4 and a negative node (−) is defined after the fourth switch S4. The flying capacitor C1 is coupled in parallel across the second S2 and third S3 switches to nodes C and D.

The half-bridge 2-level fundamental switching leg 205 is coupled in parallel with the 3-level flying capacitor leg 203 and comprises two unidirectional controlled switches S5, S6 coupled together in series. A positive node (+) is defined beginning at the fifth switch S5, a node B is defined between the fifth switch S5 and the sixth switch S6 and a negative node (−) is defined after the sixth switch S6.

A direct current voltage source VDC (+,−) is coupled to the positive (+) and negative (−) nodes across the 3-level flying capacitor leg 203 and the 2-level fundamental switching leg 205. The VDC voltage source has a value of 2V, while the flying capacitor C1 has an initial voltage charge of V. Before the inverter 201 produces a sinusoidal output voltage, the flying capacitor C1 charges to a voltage V. This takes place during an initialization phase.

The voltage produced between the nodes A and B is the output voltage. The voltage generated by the inverter 201 is a PWM waveform having the following 5 levels: +2V, +V, 0, −V, −2V. While generating these voltage levels, the inverter 201 also maintains the flying capacitor Cl voltage charged to an average value equal to the initial charging voltage V.

Typical unidirectional controlled switches comprise power semiconductors such as Insulated-Gate Bipolar Transistors (IGBTs) with an anti-parallel diode across their emitter-collector junctions. An IGBT is a three-terminal power semiconductor device having an isolated Field Effect Transistor (FET) for the control input (gate (1)) and a bipolar power transistor as a switch (collector (3)-emitter (2)). The power semiconductor devices can also be Metal-Oxide-Semiconductor Field-Effect Transistors (MOSFETs), Integrated Gate-Commutated Thyristors (IGCTs), Gate Turn-Off Thyristors (GTOs), or other types. The IGBT emitter is equivalent to a MOSFET source, or an IGCT or GTO anode. The IGBT collector is equivalent to a MOSFET drain or an IGCT or GTO cathode. For this disclosure, the unidirectional controlled switches are treated as two terminal (collector-emitter) devices. For the unidirectional controlled switches S1, S2, S3, S4, S5, S6 the anode of the anti-parallel diode is coupled to the emitter.

There are four possible states for the 3-level flying capacitor leg 203 that can be generated with respect to a voltage between node A and a fictitious midpoint O of the VDC supply. If the VDC supply voltage is 2V and the flying capacitor C1 voltage is V, the voltage V_{AO} can have three distinct values as shown in Table I.

TABLE I

| State | S₁ | S₂ | V_{AO} |
|---|---|---|---|
| 1 (S₃S₄) | 0 | 0 | −V |
| 2 (S₂S₄) | 0 | 1 | 0 |
| 3 (S₁S₃) | 1 | 0 | 0 |
| 4 (S₁S₂) | 1 | 1 | +V |

In Table I, a value of 1 for switch Sₓ indicates switch Sₓ is conducting and a value of 0 indicates switch Sₓ is not conducting. States 2 and 3 produce the same voltage and have an opposite effect on the state of charge of the flying capacitor C1. Switches S1 and S4 are always switched in opposite—when one is conducting the other one is not. Similarly, switches S2 and S3 are always switched in opposite—when one is conducting the other one is not. In general notation SₓS_{y} indicates which switches Sₓ and S_{y} are conducting.

A positive current output at node A, state 2 (switches S₂ and S₄ conduct), will lead to a discharge of the flying capacitor C1 voltage, while state 3 (switches S₁ and S₃ conduct), will charge the flying capacitor C1. The effect of states 2 and 3 are reversed when a negative current is output at node A. Therefore, alternating between states 2 and 3 when a zero voltage needs to be synthesized can be used to perform capacitor voltage balancing. Because states 2 and 3 generate a zero voltage level, they are referred to as zero states. One prior art PWM principle used for a flying capacitor leg is the Phase-Shifted (PS) method which uses two triangle carriers with a 180 degree phase shift. However, while the PS method provides capacitor voltage balancing, it does not produce an optimum harmonic spectrum and generates transitions similar to a 2-level inverter when the reference sine wave amplitude used for modulation is above 0.5. To obviate this limitation, embodiments use PWM to generate PWM pulses using two triangular carriers that are in-phase with each other. In addition to maintaining the flying capacitor C1 voltage balancing, embodiments minimize the switching performed by S1, S2, S3 and S4 in order to increase inverter 201 efficiency. For an optimum harmonic spectrum, when the output generated by the inverter 201 is positive, the waveform must switch only between 0 and V and between V and 2V levels. The zero states are located at the beginning and end of each of the following switching sequences Seq.1 , Seq.2, Seq.3 and Seq.4

Seq.1=S₁S₃→S₁S₂→S₁S₃,

Seq.2=S₁S₃→S₁S₂→S₂S₄,

Seq.3=S₂S₄→S₁S₂→S₂S₄, and

Seq.4=S₂S₄→S₁S₂→S₁S₃.

Each switching sequence Seq.1, Seq.2, Seq.3 and Seq.4 occupies one cycle (period) of a triangle carrier. One choice would be to only use Seq.2 or Seq.4 as they use both S₁S₃ and S₂S₄ states during one switching period and therefore the voltage across the flying capacitor C1 could be easily balanced. However this would create an unwanted situation because if only Seq.4 was used, there would be a case where all four switches will change state at the same time: at the end of one switching period S₁ and S₃ would conduct and in the next switching period S₂ and S₄ would conduct. A similar case can be described if only Seq.2 is used. This will lead to increased switching losses as well as increased common-mode voltage being generated with an adverse affect due to increased electromagnetic interference.

To counteract this, for the case where a “mapped” modulating function (f(M)) is positive, embodiments apply the following optimum order of switching sequences to minimize switching—Seq.1, Seq.2, Seq.3, Seq.4.

However, flying capacitor C1 voltage balancing only takes place during Seq.2 and Seq.4, while during Seq.1 and Seq.3, depending on the current polarity, voltage will either increase or decrease across the flying capacitor C1. To counteract this affect, the order in which Seq.1 and Seq.3 are applied are changed on a fundamental frequency cycle basis. Whatever voltage unbalance results across the flying capacitor C1 during one fundamental frequency cycle as a result of applying Seq.1 and Seq.3, it is counteracted during the next fundamental frequency cycle by reversing the order of switching sequences—Seq.3, Seq.4, Seq.1, Seq.2.

During a “first” fundamental frequency f_{f} cycle, if the mapped modulation function (f(M)) is positive—Seq.1, Seq.2, Seq.3, Seq.4 are used and during a “second” fundamental frequency f_{f} cycle, if the mapped modulation function (f(M)) is positive—Seq.3, Seq.4, Seq.1, Seq.2 are used. This process is continuously repeated and it ensures that when the mapped modulation function f(M) is positive the switching operations for switches S1, S2, S3 and S4 are reduced, because during sequence Seq.1, switches S1 and S4 are not switching, while during sequence Seq.3, switches S2 and S3 are not switching.

For an optimum harmonic spectrum, when the output waveform generated by the inverter 201 is negative, the waveform must switch only between 0 and −V and between −V and −2V levels. The zero states are located in the middle of each of the following switching sequences Seq.5 and Seq.6

Seq.5=S₃S₄→S₁S₃→S₃S₄, and

Seq.6=S₃S₄→S₂S₄→S₃ S₄

Seq.5 and Seq.6 could be modified and split the middle zero state between S₁S₃ and S₂S₄ to ensure voltage balancing takes place on each switching period.

However, this would lead to switches S₁, S₂, S₃ and S₄ commutating at the same time, in the middle of the switching period with similar adverse affect as described above for the case where the inverter 201 generated waveform was positive.

To counteract this, for the case where the mapped modulation function (f(M)) is negative, embodiments apply the following optimum order of switching sequences to minimize switching—Seq.5, Seq.6.

But since the voltage across the flying capacitor C1 is not balanced during the switching period, a net voltage increase or decrease would appear during each fundamental frequency cycle. The same principle used for the case when the mapped modulation function (f(M)) is positive is applied here and the sequence reverses the order in which the redundant states S₁S₃ and S₂S₄ are applied every fundamental cycle. Whatever voltage unbalance results across the flying capacitor C1 during one fundamental frequency cycle as a result of applying Seq.5 and Seq.6 in this order, it is counteracted during the next fundamental frequency cycle by reversing the order of switching sequences—Seq.6, Seq.5.

During the “first” fundamental frequency f_{f} cycle, if the mapped modulation function (f(M)) is negative—Seq.5, Seq.6 are used and during the “second” fundamental frequency f_{f} cycle, if the mapped modulation function (f(M)) is negative—Seq.6, Seq.5 are used. This process is continuously repeated.

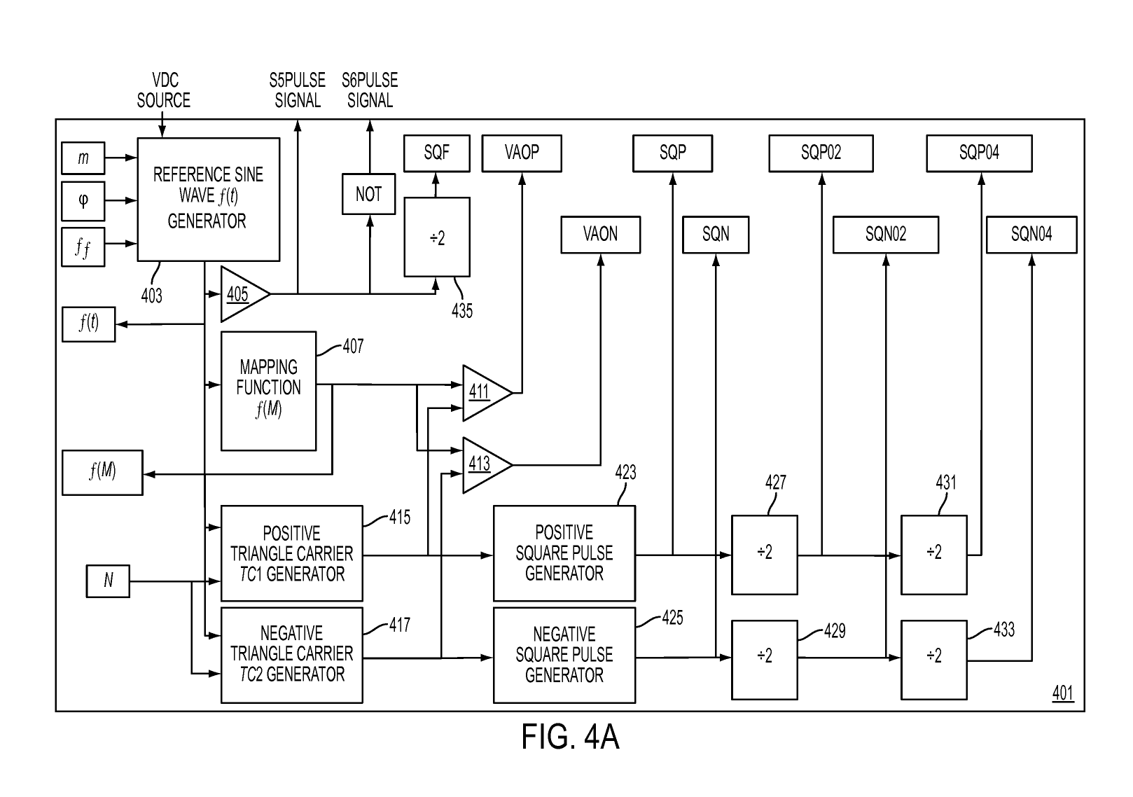

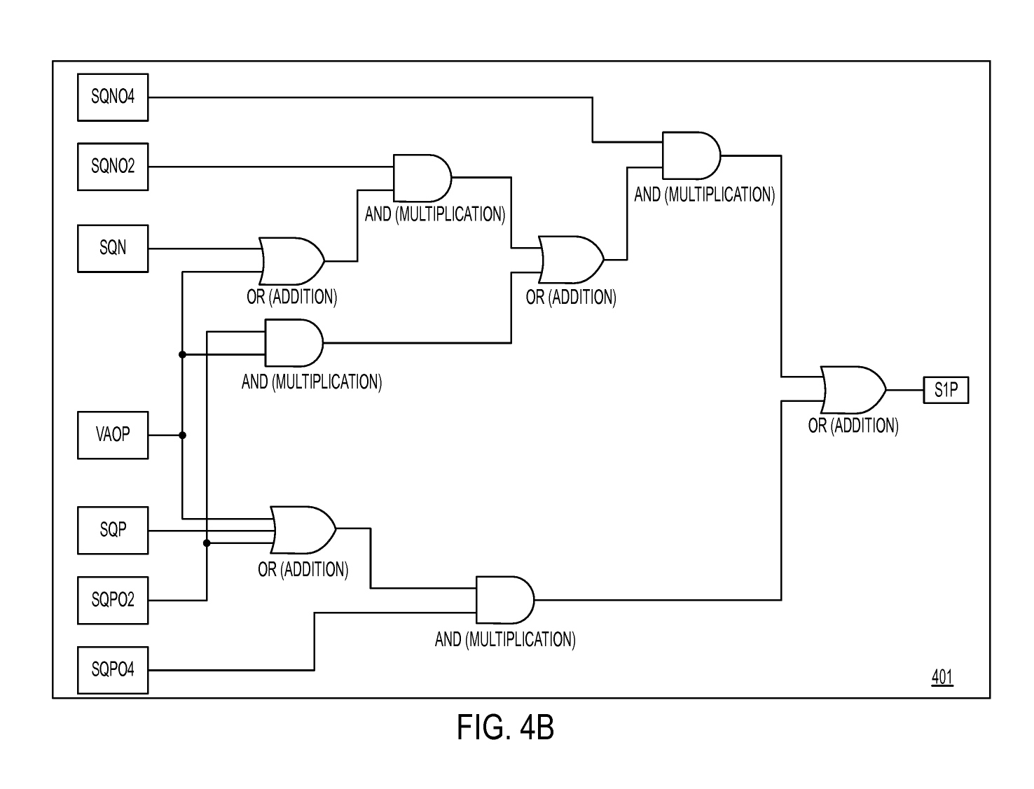

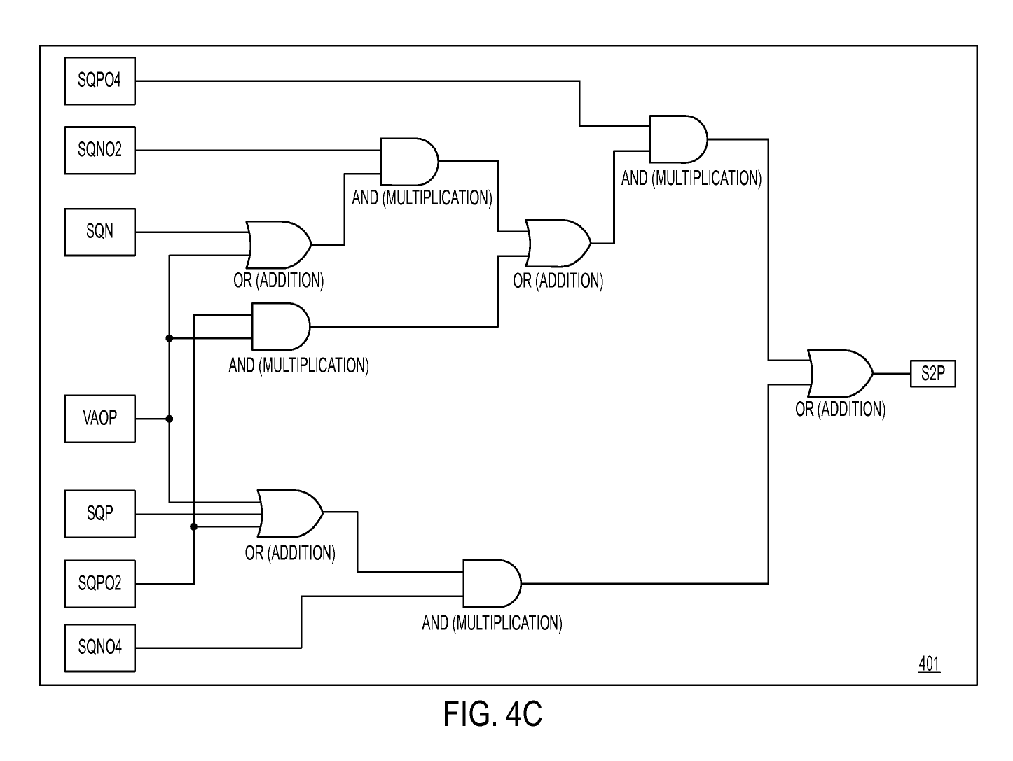

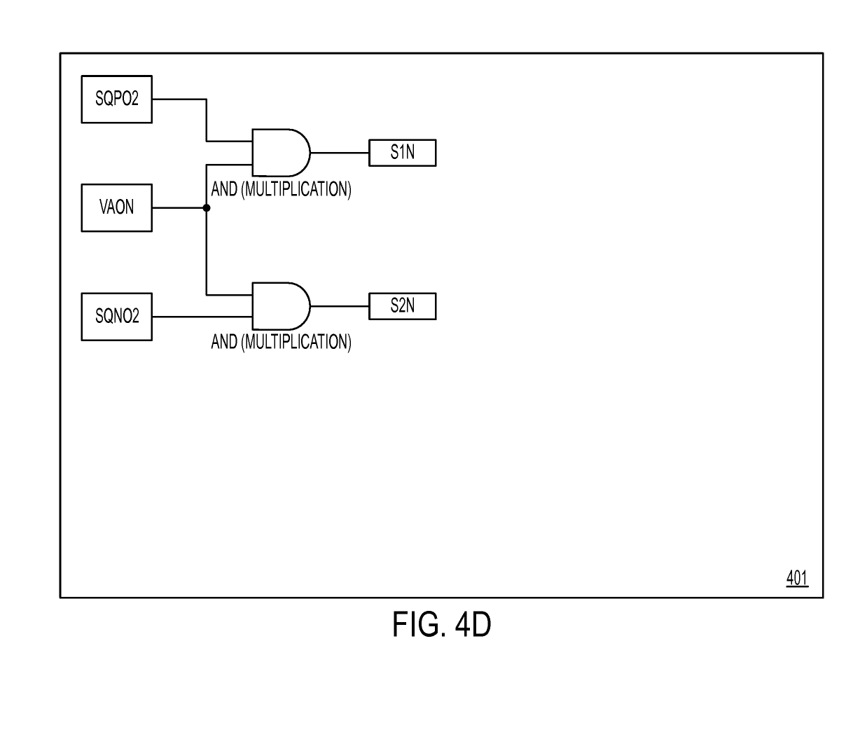

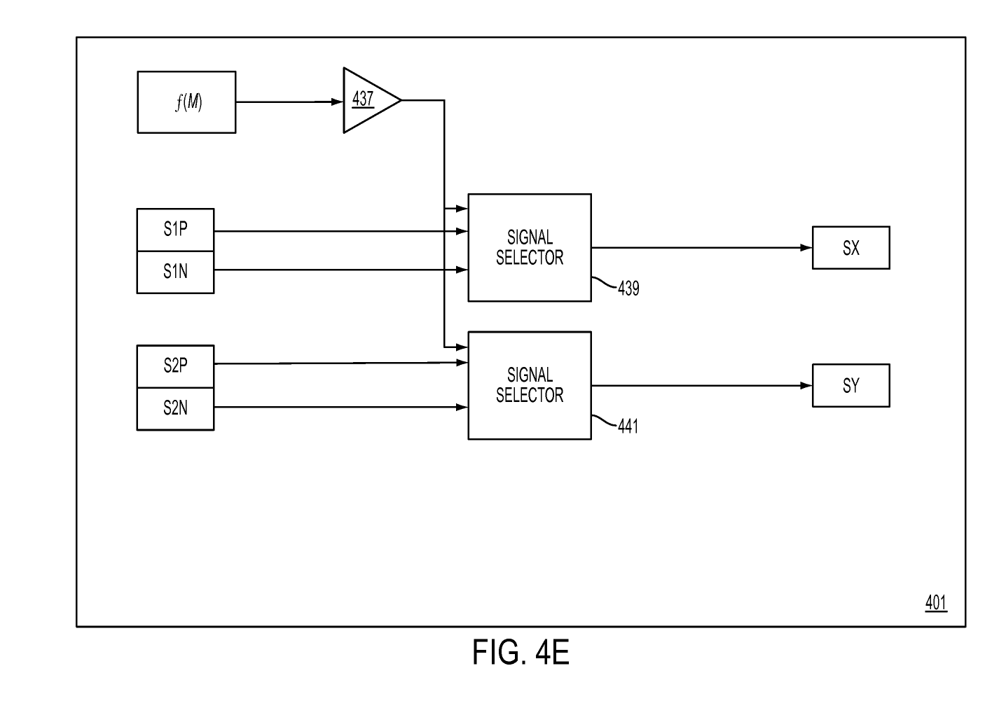

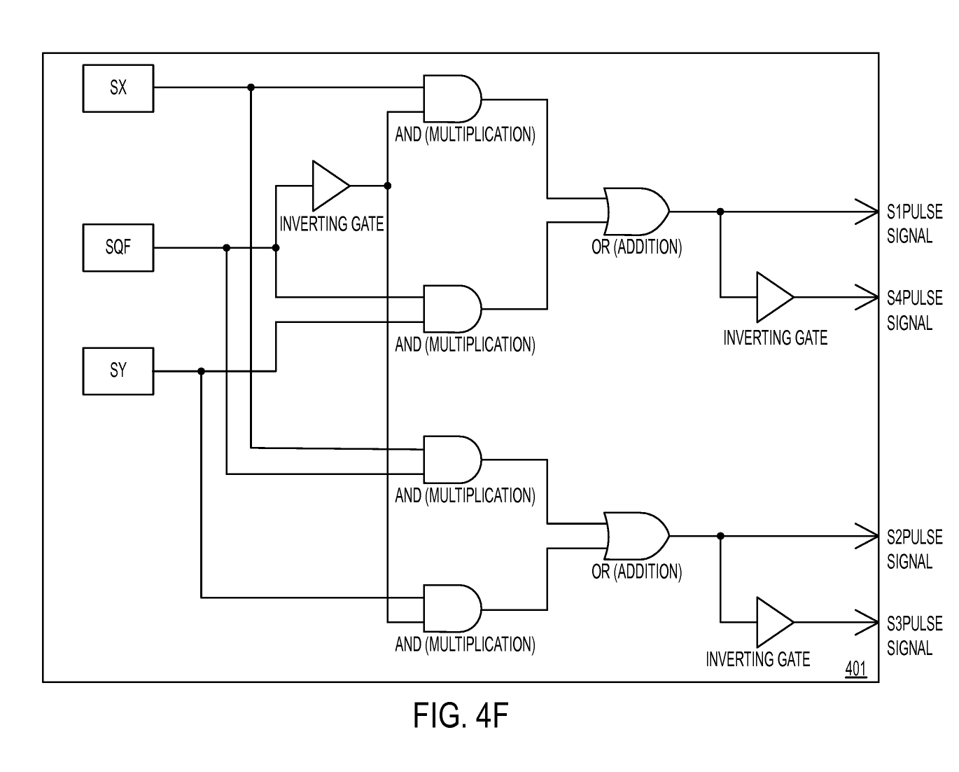

The single-phase, 5-level inverter topology 201 operates in a hybrid configuration since the 3-level flying capacitor leg 203 uses PWM to switch and the half-bridge 2-level leg 205 uses a fundamental frequency f_{f} to switch. FIGS. 4A-F show an inverter 201 switch waveform synthesizer 401 that synthesizes the switch signal waveforms S1PULSE, S2PULSE, S3PULSE, S4PULSE, S5PULSE and S6PULSE to control switches S1, S2, S3, S4, S5 and S6 respectively. The switch waveform synthesizer 401 may be implemented as discrete components, as an Application Specific Integrated Circuit (ASIC), as a Field-Programmable Gate Array (FPGA) or as a program downloaded to a Digital Signal Processor (DSP).

A sine wave generator 403 generates a reference sine wave f(t) at a desired fundamental frequency f_{f}, amplitude and phase as

f(y)=M=m sin(ωt+φ), (1)

where −1≦M≦1, m is the sine amplitude, ω=2πf_{f}, φ is the initial phase angle of the sine function and t is time. The fundamental frequency f_{f} may be 50 or 60 Hz. For a single-phase inverter 201 application, the initial phase angle φ is 0. The amplitude m varies between 0 and 1 and corresponds to the minimum and maximum voltage that can be produced by the inverter 201. The VDC supply determines the maximum achievable output voltage.

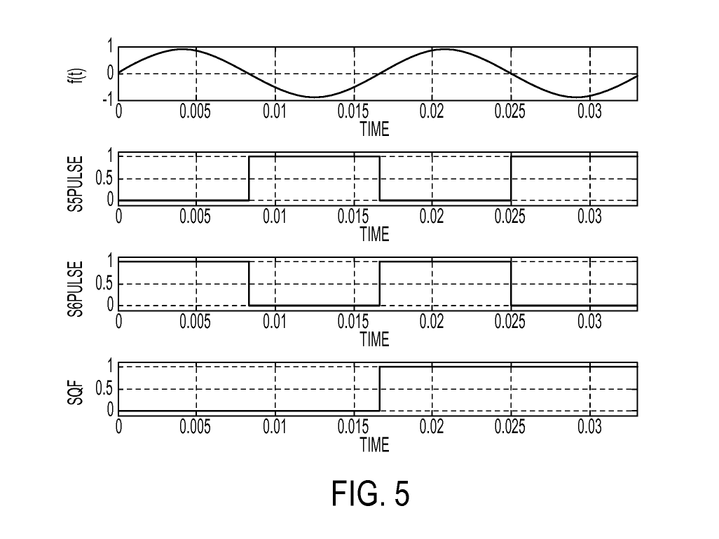

The half-bridge 2-level leg 205 switches at the fundamental frequency f_{f}. f(t) is input to a comparator 405 and compared with zero. If f(t)>0, switch S5 does not conduct (off) and switch S6 conducts (on). Switches S5 and S6 are mutually exclusive. If switch S5 is not off, switch S6 is off. FIG. 5 shows the generated reference sine wave f(t) and the switch signal waveforms S5PULSE and S6PULSE for switches S5 and S6 over two fundamental frequency f_{f} cycles.

The output of comparator 405 is input to a frequency divider 435 that divides the compared reference sine wave f(t) frequency by two and generates a signal SQF. FIG. 5 shows the generated signal SQF.

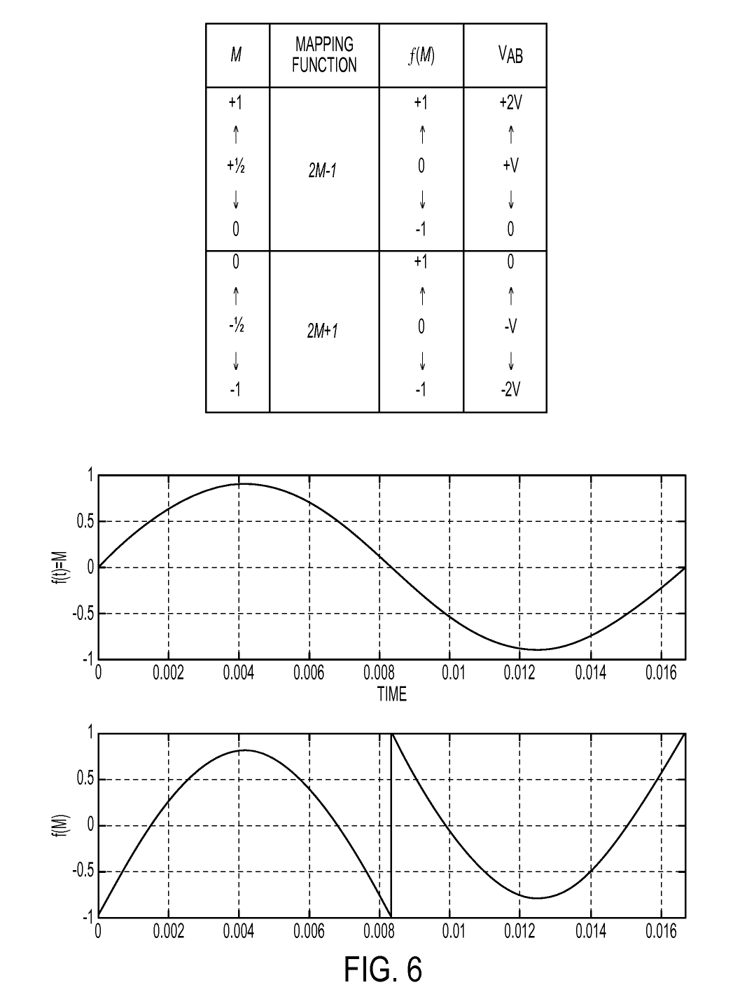

A mapping function f(M) ensures that with the constraint of having one half-bridge 2-level leg 205 clamped to either the positive or the negative VDC (+,−) source, the Vac output waveform (between nodes A and B) will only have zero to positive (0 to V or V to 2V), or zero to negative (0 to −V or −V to −2V) transitions during the positive and negative fundamental frequency f_{f} half-cycles. Without mapping the reference sine wave f(t), unwanted transitions would occur. For example, during the positive (negative) fundamental frequency f_{f} half-cycle, there would be transitions between zero and negative (positive) levels. This would have a detrimental affect on the Vac output voltage waveform quality. FIG. 6 shows the mapping function f(M) and the levels V_{AB} generated by the inverter 201 based on the time variation of the reference sine wave f(t) amplitude.

The reference sine wave f(t) is input to a mapping function 407. The mapping function 407 output f(M) is defined as

f(M)=2M−1, if M>0, or

f(M)=2M+1, if M≦0. (2)

The mapping function 407 maps the reference sine wave generator f(t) 403 output by multiplying it by 2 and adding or subtracting 1 based on the reference sine wave f(t) polarity.

The output of the mapping function 407 is input to a comparator 411 which compares f(M) with a positive triangle carrier TC1 415. The output of the mapping function block 407 is also input to a comparator 413 which compares f(M) with a negative triangle carrier TC2 417.

The positive triangle carrier wave TC1 and the negative triangle carrier wave TC2 are generated each having a period T

$${T}_{S} = \frac{1}{{f}_{S}} \qquad ( 3 )$$

where fₛ is the frequency of triangle carriers TC1 and TC2.

The carriers TC1 and TC2 are used to synthesize the switch signal waveforms S1PULSE, S2PULSE, S3PULSE and S4PULSE that control the 3-level flying capacitor leg 203 switches S1, S2, S3 and S4. Carrier TC1 is a periodic positive triangle waveform and carrier TC2 is a periodic negative triangle waveform. The relationship between the triangle carriers TC1 and TC2 frequency fₛ and the fundamental frequency f_{f} is

T_{f}=T_{S}·N, (4)

where N is an integer. N can be chosen based on the power level of the inverter and the cooling available for the semiconductors. Typically, in a low power range (1-3 kilowatts), the switching frequency could be very high (20-40 kHz, N equal to 400-800) because the IGBT switching losses are small. For high power (hundreds of kilowatts), IGBT switching losses are very high so the switching frequency is 1-3 kHz, which means N could be as low as 20-60. The choice of N relates to tolerable losses for a given application.

The positive triangle waveform generator 415 generates carrier TC1 defined as

$$\begin{matrix}TC 1 ( t ) = \begin{matrix}- \frac{2}{{T}_{S}} \cdot t + 1 , & when 0 < t < \frac{{T}_{S}}{2} , or\end{matrix} \\ = \begin{matrix}\frac{2}{{T}_{S}} \cdot t - 1 , & when \frac{{T}_{S}}{2} < t < {T}_{S} ,\end{matrix}\end{matrix} \qquad ( 5 )$$

and the negative triangle waveform generator 417 generates carrier TC2 defined as

$$\begin{matrix}TC 2 ( t ) = \begin{matrix}- \frac{2}{{T}_{S}} \cdot t , & when 0 < t < \frac{{T}_{S}}{2} , or\end{matrix} \\ = \begin{matrix}\frac{2}{{T}_{S}} \cdot t - 2 , & when \frac{{T}_{S}}{2} < t < {T}_{S} .\end{matrix}\end{matrix} \qquad ( 6 )$$

The comparison 411 of carrier TC1(t) with f(M) outputs a signal VAOP that is 1 when f(M)>TC1(t) and 0 when f(M) is not greater than TC1(t). The comparison 413 of carrier TC2(t) with f(M) outputs a signal VAON that is 1 when f(M)>TC2(t) and 0 when f(M) is not greater than TC2(t).

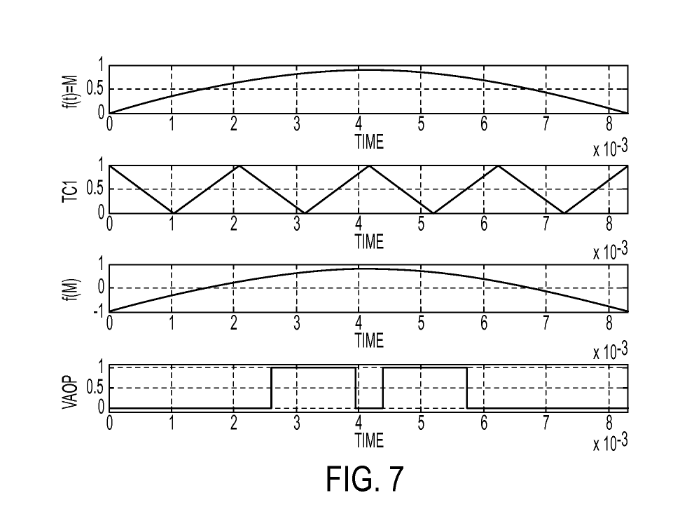

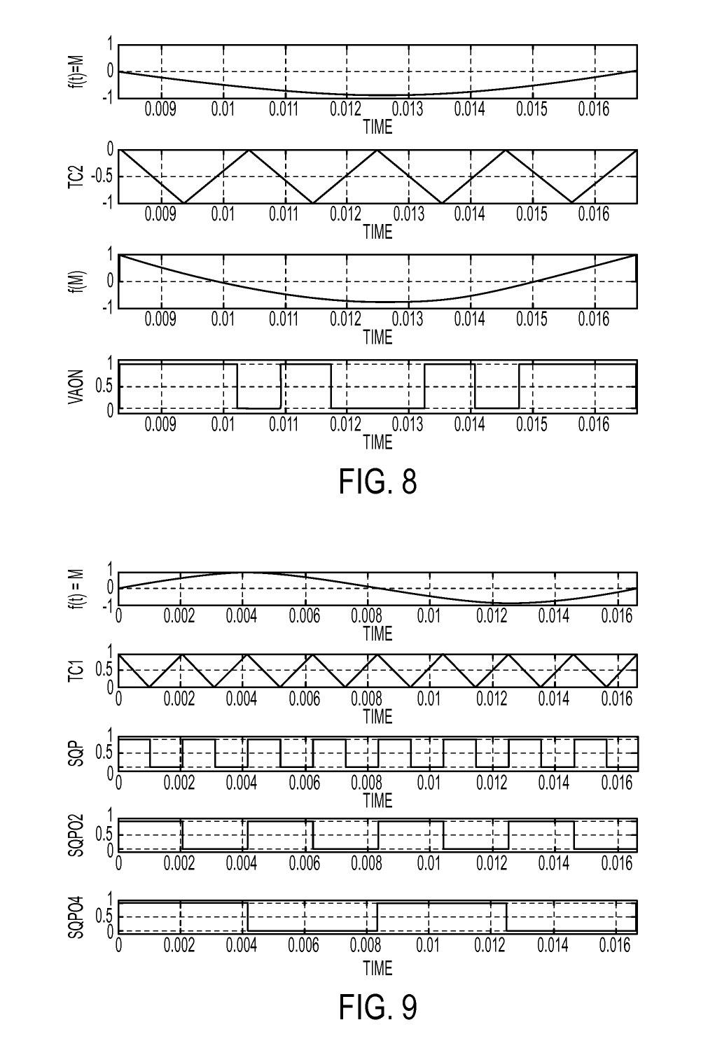

FIG. 7 shows the reference sine wave f(t), the positive triangle carrier TC1 with N=8, the mapped function f(M), and signal VAOP. FIG. 8 shows the reference sine wave f(t), the negative triangle carrier TC2 with N=8, the mapped function f(M), and signal VAON.

A signal SQP with a frequency fₛ is generated 423 based on the triangle carrier period Tₛ

$$\begin{matrix}SQP = \begin{matrix}1 , & when 0 < t < \frac{{T}_{S}}{2} , or\end{matrix} \\ = \begin{matrix}0 , & when \frac{{T}_{S}}{2} < t < {T}_{S} .\end{matrix}\end{matrix} \qquad ( 7 )$$

A signal SQN with a frequency fₛ is generated 425 based on the triangle carrier period Tₛ

$$\begin{matrix}SQN = \begin{matrix}0 , & when 0 < t < \frac{{T}_{S}}{2} , or\end{matrix} \\ = \begin{matrix}1 , & when \frac{{T}_{S}}{2} < t < {T}_{S} .\end{matrix}\end{matrix} \qquad ( 8 )$$

The signal SQP is input to a frequency divider 427 that divides the signal SQP frequency by two. The output signal SQPO2 with a frequency

$$\frac{{f}_{s}}{2}$$

is defined as

SQPO2=1, when 0<t<T_{S}, or

=0, when T_{S}<t<2·T_{S}. (9)

The signal SQN is input to a frequency divider 429 that divides the signal SQN frequency by two. The output signal SQNO2 with a frequency

$$\frac{{f}_{s}}{2}$$

is defined as

SQNO2=0, when 0<t<T_{S}, or

=1, when T_{S}<t<2·T_{S}. (10)

The signal SQPO2 is input to a frequency divider 431 that divides the signal SQPO2 frequency by two. The output signal SQPO4 with a frequency

$$\frac{{f}_{s}}{4}$$

is defined as

SQPO4=1, when 0<t<2·T_{S}, or

=0, when 2·T_{S}<t<4·T_{S}. (11)

The signal SQNO2 is input to a frequency divider 433 that divides the signal SQNO2 frequency by two. The output signal SQNO4 with a frequency

$$\frac{{f}_{s}}{4}$$

is defined as

SQNO4=0, when 0<t<2·T_{S}, or

=1, when 2·T_{S}<t<4·T_{S}. (12)

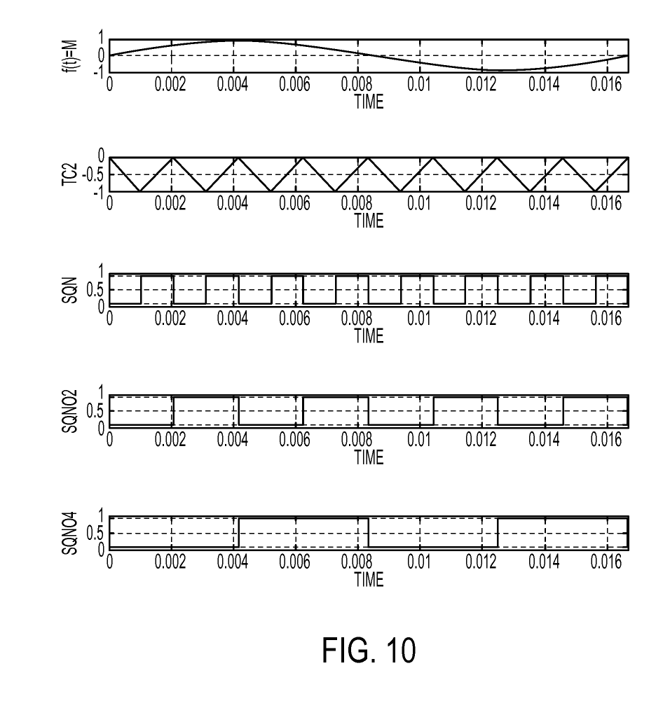

FIG. 9 shows reference sine wave f(t), positive triangle carrier TC1, SQP, SQPO2 and SQPO4. FIG. 10 shows reference sine wave f(t), negative triangle carrier TC2, SQN, SQNO2 and SQNO4.

Embodiments use the generated signals VAOP, SQP, SQPO2 and SQPO4, and VAON, SQN, SQNO2 and SQNO4 to further generate the switch signal waveforms S1PULSE, S2PULSE, S3PULSE and S4PULSE.

Signals S1P, S2P, S1N and S2N are generated using logic combinations of the previously generated signals

S1P=SQPO4(SQPO2+SQP+VAOP)+SQNO4[VAOPSQPO2+SQNO2(SQN+VAOP)], (13)

S2P=SQNO4(SQPO2+SQP+VAOP)+SQPO4[VAOPSQPO2+SQNO2(SQN+VAOP)], (14)

S1N=VAONSQPO2, and (15)

S2N=VAONSQNO2. (16)

FIGS. 4B, 4C and 4D show logic functions that represent the Boolean logic in (13)-(16).

Based on the polarity of the mapped function f(M), signals SX and SY are generated from signals S1P and S1N, and, S2P and S2N. The mapped function f(M) is input to a comparator 437 which outputs a logic 1 when f(M)÷0 and 0 when f(M)<0. A signal selector 439 chooses either signal S1P or signal S1N as signal SX depending on the mapped function f(M) polarity. Similarly, a signal selector 441 chooses either signal S2P or signal S2N as signal SY depending on the mapped function f(M) polarity.

SX=S1P, when f(M)>0, or

=S1N, when f(M)<0, and (17)

SY=S2P, when f(M)>0, or

=S2N, when f(M)<0. (18)

FIG. 4E shows the logic functions for the comparisons in (17) and (18).

The switch signal waveform S1PULSE is generated from

S1PULSE=SX S̅Q̅F̅+SYSQF. (19)

The switch signal waveform S2PULSE is generated from

S2PULSE=SY S̅Q̅F̅+SXSQF. (20)

The switch signal waveform S3PULSE is generated from

S3PULSE= S̅2̅P̅U̅L̅S̅E̅. (21)

The switch signal waveform S4PULSE is generated from

S4PULSE=S1PULSE (22)

FIG. 4F shows logic functions that represent the Boolean logic in (19)-(22).

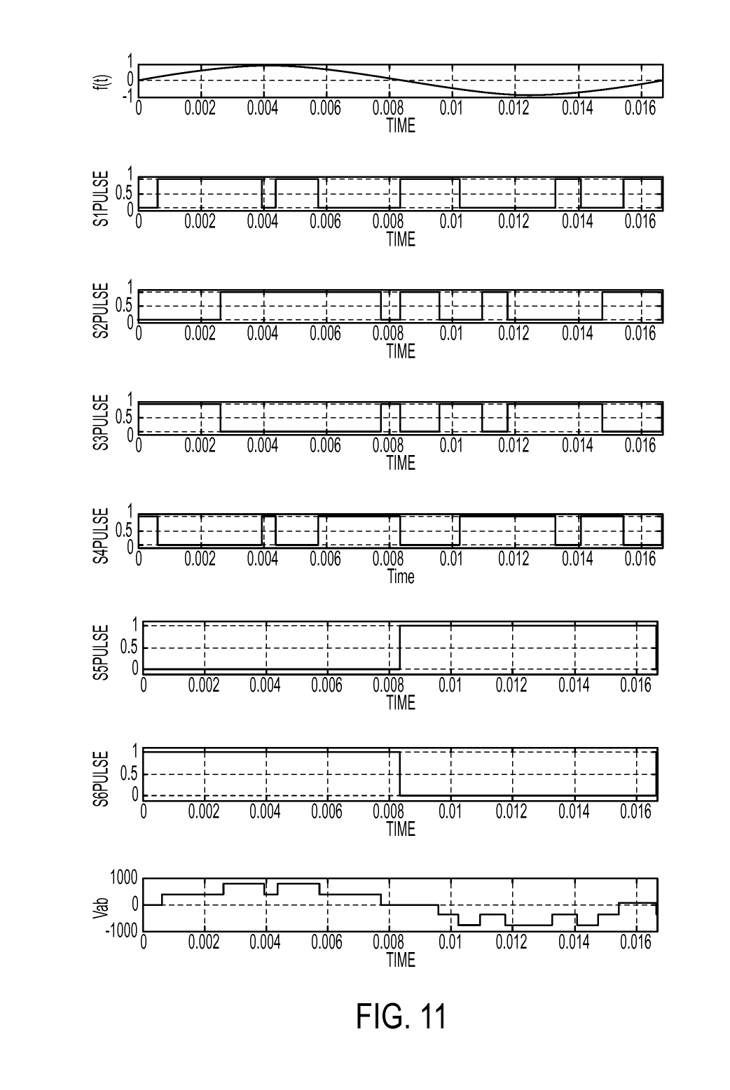

FIG. 11 shows reference sine wave f(t), the switch signal waveforms S1PULSE, S2PULSE, S3PULSE, S4PULSE, S5PULSE and S6PULSE, and the resultant voltage levels between nodes A and B that form the Vac output. Switches S₃ and S₄ are always in opposite state with respect to switches S₂ and S₁, respectively, as in (17) and (18). Therefore, only the switch signal waveforms for switches S₁ and S₂ need to be developed.

For the three-phase inverter 301 shown in FIG. 3, the topology comprises three single-phase 201, 5-level inverters 303A, 303B, 303C with line matching transformers TA, TB and TC. The three single-phase transformers have their secondaries connected in a wye. The isolation transformers are required for grid voltage adaptation and for local grid compliance.

The control for the three-phase inverter 301 is based on the control 401 for the single-phase inverter 201. Three control systems 401A, 401B, 401C (not shown) are used to control phases A, B and C. Each reference sine wave f_{A}(t), f_{B}(t), f_{C}(t) is displaced by

$$\frac{2 π}{3}$$

(120 degrees). This is performed by selecting the initial phase angle φ of each reference sine wave generator 403A, 403B, 403C (not shown) as follows: for phase A, the reference sine wave f_{A}(t) initial phase angle φ is 0, for phase B the reference sine wave f_{B}(t) initial phase angle φ is

$$\frac{2 π}{3}$$

(120 degrees) and for phase C the reference sine wave f_{C}(t) initial phase angle φ is

$$\frac{4 π}{3}$$

(240 degrees)

$$\begin{matrix}{f}_{A} ( t ) = M = m sin ( ω t ) + CMO , & ( 23 ) \\ {f}_{B} ( t ) = M = m sin ( ω t - \frac{2 π}{3} ) + CMO , and & ( 24 ) \\ {f}_{C} ( t ) = M = m sin ( ω t - \frac{4 π}{3} ) + CMO . & ( 25 )\end{matrix}$$

The reference sine waves f_{A}(t), f_{B}(t), f_{C}(t) may include Common Mode Offset (CMO) which is added to produce more line-line voltage from a given direct current voltage source VDC. The addition of the CMO term has no adverse effect on the line-line voltage of a balanced three-phase system. CMO allows the inverter 301 to produce approximately 15.5% more voltage by increasing the reference sine wave amplitudes m to 1.155.

The three-phase inverter 301 uses 18 switches (phase A—S1A, S2A, S3A, S4A, S5A, S6A, phase B—S1B, S2B, S3B, S4B, S5B, S6B and phase C S1C, S2C, S3C, S4C, S5C, S6C) and three flying capacitors C1A, C1B, C1C. Of the 18 switches, six devices switch at the desired fundamental frequency f_{f}. By comparison, a prior art 5-level diode-clamped inverter uses 24 switches, all PWM switching, and 12 diodes. A prior art flying capacitor topology requires 24 switching devices, all PWM switching, and 9 flying capacitors.

Embodiments reduce the cost of a three-phase 5-level inverter and produce an optimum output voltage spectrum with flying capacitor voltage balancing. The advantages of the three-phase inverter 301 are: 1) a three-phase 5-level topology can be obtained using only 12 PWM switching devices and 6 fundamental switching devices, 2) only 3 flying capacitors are used and voltage balancing is performed, 3) due to the fixed fundamental frequency f_{f} (50/60 Hz) in grid and UPS applications, the flying capacitors C1A, C1B, C1C do not suffer from the limitations encountered in large motor drives operating at low fundamental frequencies, 4) for an LCL-type filter, an inverter 301 side inductor can be the transformer leakage inductance while the grid side inductance operates on the five-level voltage thereby reducing losses, 5) the inverter 301 provides a neutral connection that can be used for a three-phase four-wire system, and 6) the inverter 301 is modular and uses half-bridge modules.

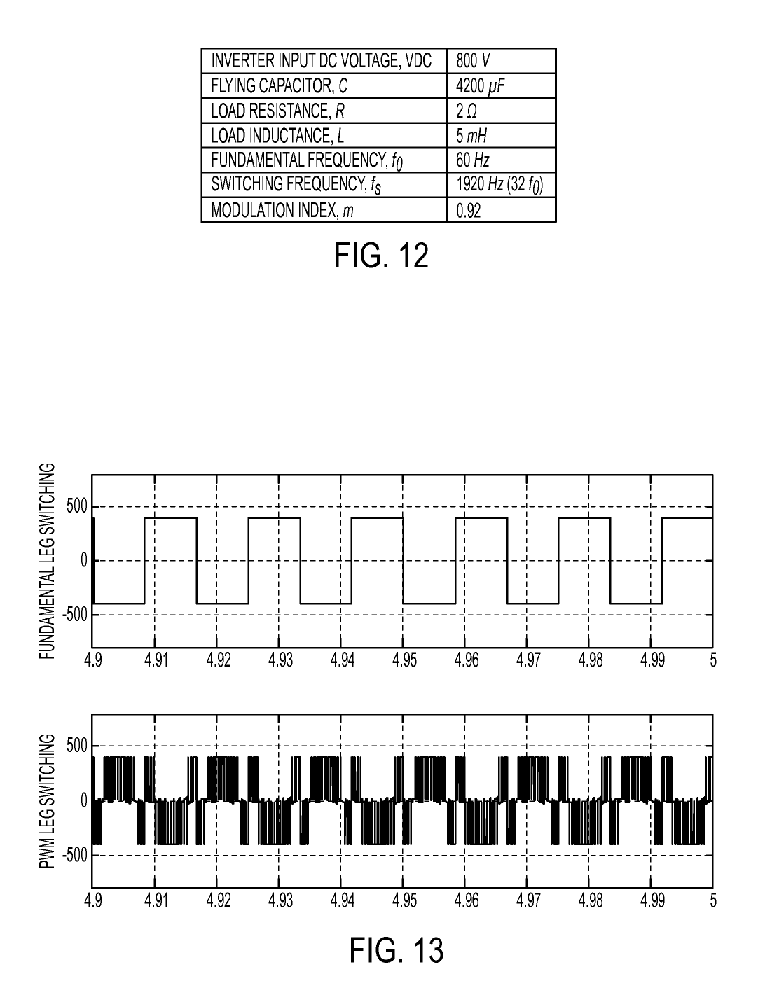

The three-phase 5-level inverter 301 was simulated in Matlab/Simulink. FIG. 12 lists the main parameters used in the simulation.

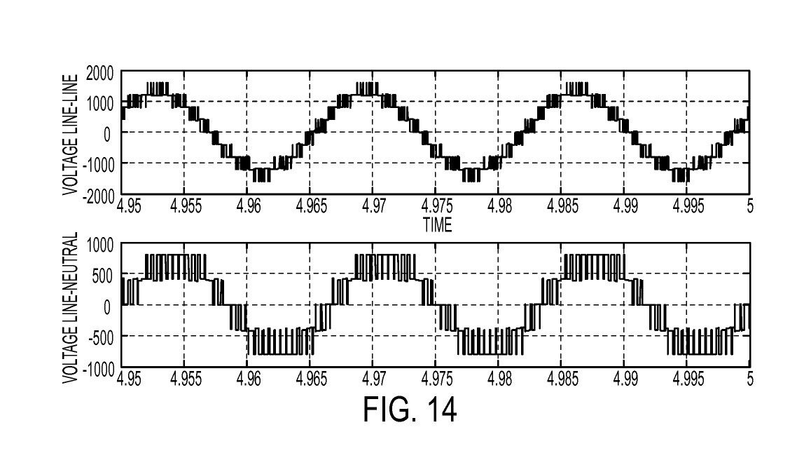

FIG. 13 shows a voltage waveform between a phase's 2-level fundamental switching leg and the fictitious VDC midpoint (the voltage between node B and a fictitious midpoint of VDC, essentially the voltage between node B and half-voltage of VDC), and the voltage between the same phase's 3-level flying capacitor leg (between node A and a fictitious midpoint of VDC) and the VDC midpoint per one phase. While neither waveform appears sine-like, the line-to-line and line-to-neutral voltages shown in FIG. 14 are sinusoidal with 9-levels and 5-levels respectively. Each single-phase inverter 303A, 303B, 303C of the three-phase inverter 301 provides 5 levels: +2V, +V, 0, −V and −2V. Since the reference sine waves f_{A}(t), f_{B}(t), f_{C}(t) are shifted 120 degrees, the individual five levels are not occurring at the same time on each phase. At the same time, each line-to-line voltage of the three-phase inverter 301 is made up by subtracting two voltages from the single-phase inverters 303A, 303B, 303C. This means that for the three-phase inverter 301 nine levels, line-to-line, are generated: +4V, +3V, +2V, +V, 0, −V, −2V, −3V, −4V, assuming that the three transformers have a 1:1 ratio between the primary and the secondary voltages

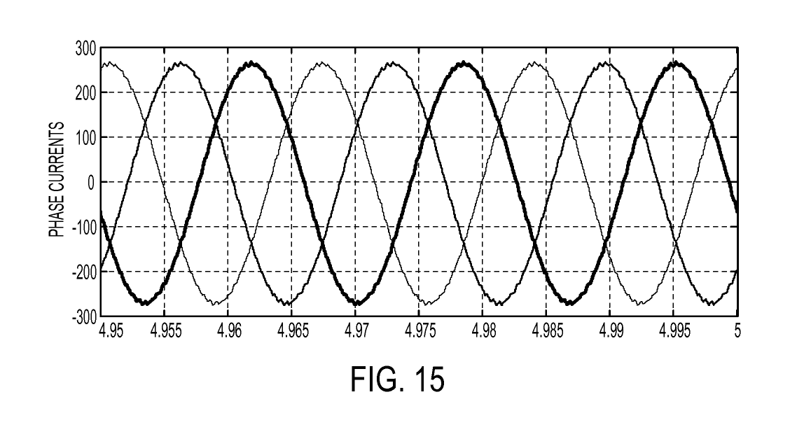

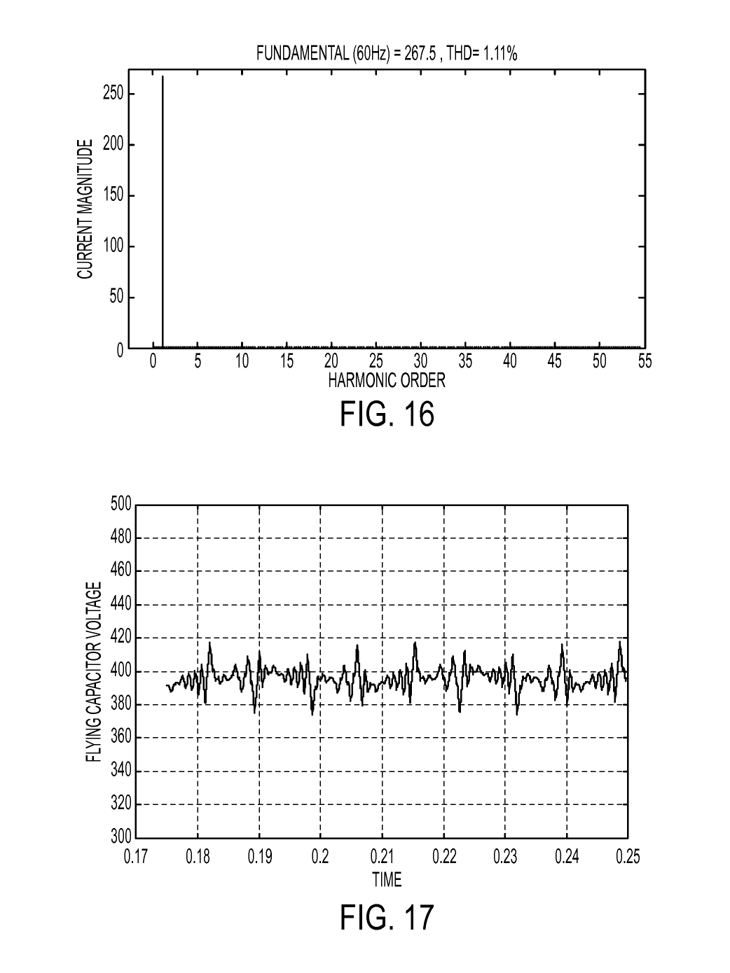

With RL loads placed on the outputs of each phase 303A, 303B, 303C, FIG. 15 shows smooth three-phase sinusoidal currents. The multilevel line-to-line voltage displayed in FIG. 15 leads to a low 1.5% Total Harmonic Distortion (THD) of the output current. FIG. 16 shows a plot of the harmonic spectrum of the phase current as calculated using a Fast Fourier Transform (FFT).

FIG. 17 shows the flying capacitor voltage between nodes C and D per phase in FIG. 2. Embodiments are able to maintain voltage at a level equal to half of the direct current voltage source VDC while reducing the number of switching devices per phase. The peak-to-peak capacitor voltage ripple is kept to within 5% of the direct current voltage source VDC voltage while the RMS ripple is restricted to approximately 2%.

One or more embodiments of the present invention have been described. Nevertheless, it will be understood that various modifications may be made without departing from the spirit and scope of the invention. Accordingly, other embodiments are within the scope of the following claims.

What is claimed is:

1. A hybrid inverter comprising:
a topology comprising:
a 3-level flying capacitor leg coupled in parallel with a half-bridge 2-level leg, the 3-level flying capacitor leg comprising:
four unidirectional controlled switches coupled together in series that define a positive node (+) beginning at a first switch S1, a node C between the first switch S1 and a second switch S2, a node A between the second switch S2 and a third switch S3, a node D between the third switch S3 and a fourth switch S4 and a negative node (−) after the fourth switch S4; and
a capacitor C1 coupled to nodes C and D; and
the half-bridge 2-level leg comprising:
two unidirectional controlled switches coupled together in series that define a positive node (+) beginning at a fifth switch S5, a node B between the fifth switch S5 and a sixth switch S6 and a negative node (−) after the sixth switch S6; and
an alternating current output defined between nodes A and B.

2. The inverter according to claim 1 wherein a unidirectional controlled switch is a power semiconductor with an anti-parallel diode across its switching junction.

3. The inverter according to claim 2 wherein the power semiconductor is an Insulated-Gate Bipolar Transistor (IGBT).

4. The inverter according to claim 1 wherein a direct current voltage source VDC is coupled to the positive node (+) and the negative node (−).

5. The inverter according to claim 4 wherein the direct current voltage source VDC is a direct energy conversion device.

6. The inverter according to claim 4 wherein the direct current voltage source VDC is a battery.

7. The inverter according to claim 1 further comprising:
an inverter switch waveform synthesizer configured to generate switch signals S1PULSE, S2PULSE, S3PULSE, S4PULSE, S5PULSE and S6PULSE that control the first switch S1, the second switch S2, the third switch S3, the fourth switch S4, the fifth switch S5, and the sixth switch S6 respectively comprising:
a reference sine wave generator configured to output a reference sine wave f(t) at a fundamental frequency f_{f}, amplitude m, phase angle φ and time t;
a first comparator configured to receive the reference sine wave f(t) and compare the reference sine wave f(t) with zero to generate the switch signal waveform S5PULSE wherein if the reference sine wave is greater than 0 switch S5 is off and if the reference sine wave is less than or equal to 0 switch S5 is on;
a not function configured to receive the switch signal waveform S5PULSE and output the switch signal waveform S6PULSE;
a first frequency divider configured to receive the switch signal waveform S5PULSE and divide the switch signal waveform S5PULSE by 2 to generate an SQF signal;
a mapping function configured to map the reference sine wave f(t) wherein the discrete time value of the reference sine wave is M and if M>0, M is mapped according to f(M)=2M−1 and if M≦0, M is mapped according to f(M)=2M+1;
a second comparator configured to receive the mapped f(M) values and compare the mapped f(M) values with a positive triangle carrier waveform TC1 wherein the second comparator outputs a signal VAOP that is 1 when f(M)>TC1(t) and 0 when f(M) is not greater than TC1(t);
a third comparator configured to receive the mapped f(M) values and compare the mapped f(M) values with a negative triangle carrier waveform TC2 wherein the third comparator outputs a signal VAON that is 1 when f(M)>TC2(t) and 0 when f(M) is not greater than TC2(t);
a positive square pulse generator with a frequency fₛ configured to output a signal SQP based on the positive triangle carrier TC1 period Tₛ wherein if
$$0 < t < \frac{{T}_{S}}{2} ,$$
the signal SQP is 1 and if
$$\frac{{T}_{S}}{2} < t < {T}_{S} ,$$
SQP is 0;
a negative square pulse generator with a frequency fₛ configured to output a signal SQN based on the negative triangle carrier TC2 period T wherein if
$$0 < t < \frac{{T}_{S}}{2} ,$$
the signal SQN is 0 and if
$$\frac{{T}_{S}}{2} < t < {T}_{S} ,$$
the signal SQN is 1;
a second frequency divider configured to receive the signal SQP, divide the signal SQP by 2 and output a signal SQPO2 that has a frequency
$$\frac{{f}_{s}}{2}$$
wherein if 0<t<Tₛ, the signal SQPO2 is 1 and if Tₛ<t≦2·Tₛ, the signal SQPO2 is 0;
a third frequency divider configured to receive the signal SQN, divide the signal SQN by 2 and output a signal SQNO2 that has a frequency
$$\frac{{f}_{s}}{2}$$
wherein if 0<t<Tₛ, the signal SQNO2 is 0 and if T<t<2·T, the signal SQNO2 is 1;
a fourth frequency divider configured to receive the signal SQPO2, divide the signal SQPO2 by 2 and output a signal SQPO4 that has a frequency
$$\frac{{f}_{s}}{4}$$
wherein if 0<t<2·Tₛ, the signal SQPO4 is 1 and if 2·Tₛ<t<4·Tₛ, the signal SQPO4 is 0;
a fifth frequency divider configured to receive the signal SQNO2, divide the signal SQNO2 by 2 and output a signal SQNO4 that has a frequency
$$\frac{{f}_{s}}{4}$$
wherein if 0<t<2·Tₛ, the signal SQNO4 is 0 and if 2·Tₛ<t<4·Tₛ, the signal SQNO4 is 1;
a signal S1P generated from signals SQP, SQN, SQPO2, SQNO2, SQPO4, SQNO4 and VAOP defined as SQPO4(SQPO2+SQP+VAOP)+SQNO4[VAOPSQPO2+SQNO2(SQN+VAOP)];
a signal S2P generated from signals SQP, SQN, SQPO2, SQNO2, SQPO4, SQNO4 and VAOP defined as SQNO4(SQPO2+SQP+VAOP)+SQPO4[VAOPSQPO2+SQNO2(SQN+VAOP)];
a signal S1N generated from signals VAON and SQPO2 defined as VAONSQPO2;
a signal S2N generated from signals VAON and SQNO2 defined as VAONSQNO2;
a fourth comparator configured to receive the mapped f(M) values and compared the mapped f(M) values wherein if f(M)>0, output a 1 and if f(M)≦0, output a 0;
a first signal selector configured to receive the signals S1P and S1N, and the output from the fourth comparator, and output a signal SX wherein if the fourth comparator output is 1, the signal S1P is output and if the fourth comparator output is 0, the signal S1N is output;
a second signal selector configured to receive the signals S2P and S2N, and the output from the fourth comparator, and output a signal SY wherein if the fourth comparator output is 1, the signal S2P is output and if the fourth comparator output is 0, the signal S2N is output; and
the switch signal S1PULSE is generated from the signals SX, SY and SQF defined as SX S̅Q̅F̅+SYSQF, the switch signal S2PULSE is generated from the signals SX, SY and SQF defined as SY S̅Q̅F̅+SXSQF, the switch signal S3PULSE is generated defined as S̅2̅P̅U̅L̅S̅E̅, and the switch signal S4PULSE is generated defined as S̅1̅P̅U̅L̅S̅E̅.

8. The inverter according to claim 7 wherein the positive triangle carrier waveform TC1 and the negative triangle carrier waveform TC2 each have a period defined as
$${T}_{S} = \frac{1}{{f}_{S}} ,$$
wherein fₛ is the frequency of triangle carriers TC1 and TC2.

9. The inverter according to claim 8 further comprising:
a positive triangle waveform generator configured to generate the positive triangle carrier waveform TC1 wherein if
$$0 < t < \frac{{T}_{s}}{2} , TC 1 is - \frac{2}{{T}_{s}} \cdot t + 1 and if$$
$$\frac{{T}_{s}}{2} < t < {T}_{s} , TC 1 is \frac{2}{{T}_{s}} \cdot t - 1 ;$$
and
a negative triangle waveform generator configured to generate the negative triangle carrier waveform TC2 wherein if
$$0 < t < \frac{{T}_{s}}{2} , TC 2 is - \frac{2}{{T}_{s}} \cdot t and if$$
$$\frac{{T}_{s}}{2} < t < {T}_{s} , TC 2 is \frac{2}{{T}_{s}} \cdot t - 2.$$

10. The inverter according to claim 7 wherein the half-bridge 2-level leg switches at fundamental frequency f_{f}.

11. The inverter according to claim 7 wherein for a single-phase hybrid inverter, the phase angle φ is 0.

12. The inverter according to claim 7 wherein the amplitude of the reference sine wave m varies between 0 and 1 and corresponds to a minimum and a maximum voltage that can be produced by the inverter.

13. The inverter according to claim 7 wherein the positive nodes (+) and negative nodes (−) of three single-phase hybrid inverters, defined as phase A, phase B and phase C, are coupled together in parallel to form a three-phase 5-level inverter topology, and the alternating current output between nodes A and B for each of the phase A, phase B and phase C inverters is coupled to the primary of a line matching transformer TA, TB and TC with the line matching transformer's TA, TB and TC secondaries coupled together in a wye configuration, the three-phase 5-level inverter outputs a line-to-neutral voltage having five levels and a line-to-line voltage having nine levels.

14. The inverter according to claim 13 wherein three inverter switch waveform synthesizers are used to control the phase A, phase B and phase C inverters and the phase angle φ for each phase's inverter switch waveform synthesizer reference sine wave f(t), defined as f_{A}(t), f_{B}(t) and f_{C}(t), is shifted 120 degrees.
